(19) United States
(12) Patent Application Publication
(10) Pub. No.: US 2014/0134872 A1
(43) Pub. Date: May 15, 2014

(54) CONNECTOR ASSEMBLY

(71) Applicants: HON HAI PRECISION INDUSTRY CO., LTD., New Taipei (TW); HONG FU JIN PRECISION INDUSTRY (ShenZhen) Co.,LTD., Shenzhen (CN)

(72) Inventors: XIA-BING GAO, Shenzhen (CN); AI-LING HE, Shenzhen (CN); LEI LIU, Shenzhen (CN); HAN-BING ZHANG, Shenzhen (CN); ZHENG-HENG SUN, New Taipei (TW)

(21) Appl. No.: 13/909,090

(22) Filed: Jun. 4, 2013

(30) Foreign Application Priority Data
Nov. 15, 2012 (CN) 2012104594438

(51) Int. Cl. H01R 13/627

(52) U.S. Cl. CPC H01R 13/6275
USPC 439/358

(57) ABSTRACT

A connector assembly includes a connector and an auxiliary device. The connector includes a connection portion, and a cable connected to a rear end of the connection portion. A latch extends up and back from a front end of the connection portion. The auxiliary device includes a fastening member fastened to the connector, and a resilient tab extending up and forward from the fastening member. A front end of the resilient tab is located above the latch.

### BACKGROUND

1. Technical Field

The present disclosure relates to a connector assembly.

2. Description of Related Art

To pull out a Registered Jack-45 (RJ-45) connector with a latch from a slot of an interface, the latch is manipulated first to disengage from the slot, then the RJ-45 connector is pulled out. The space near the interface may be small sometimes, thus it is inconvenient for an operator to use the finger to manipulate the latch of the RJ-45 connector.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an embodiment of a connector assembly.

FIG. 2 is an exploded, isometric view of FIG. 1.

FIG. 3 is an inverted view of FIG. 2.

FIG. 4 is an exploded, isometric view of the connector assembly of FIG. 1 with an electronic device.

FIG. 5 is an assembled, isometric view of FIG. 4.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

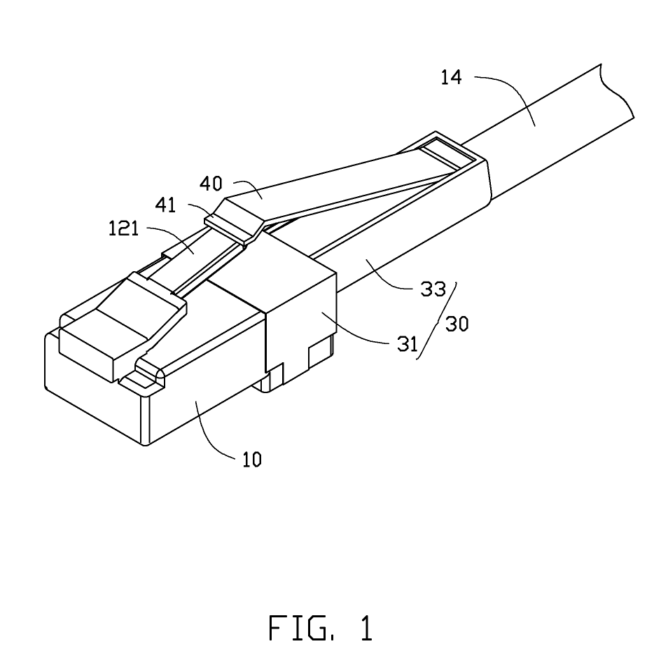

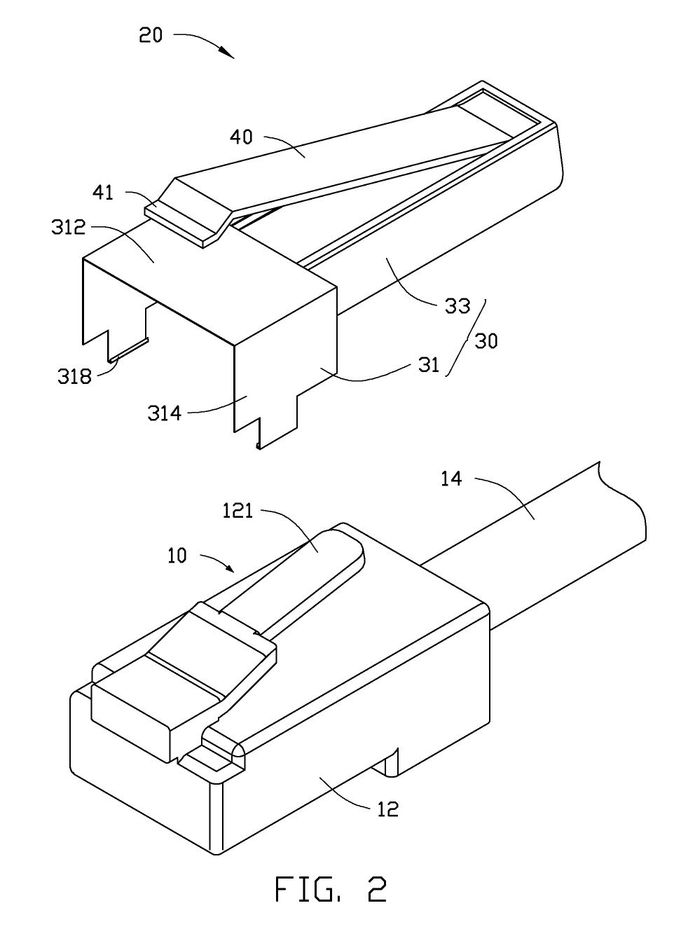

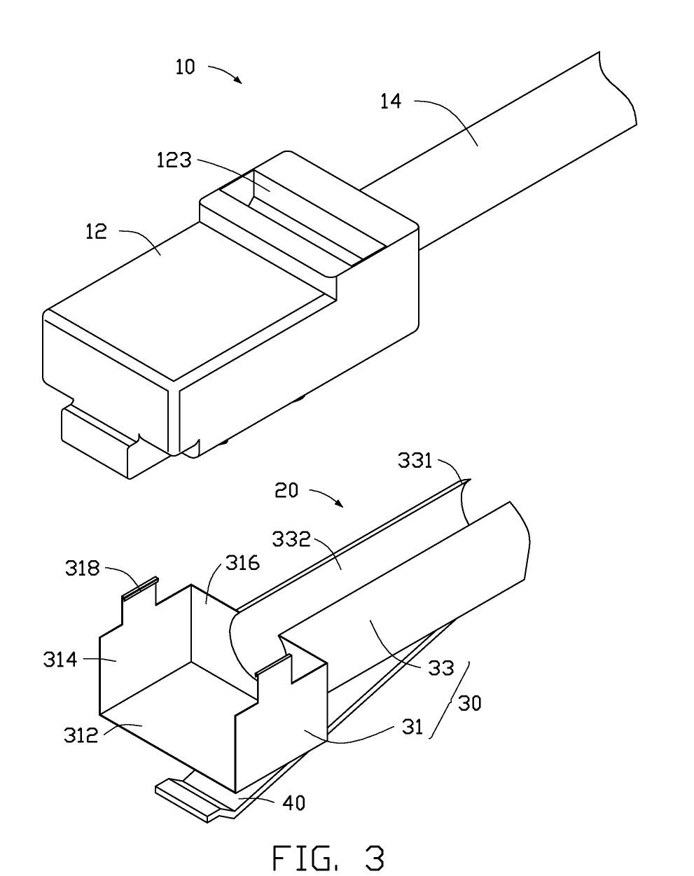

FIGS. 1-3 show an exemplary embodiment of a connector assembly. The connector assembly includes a connector 10 and an auxiliary device 20.

The connector 10 includes a connection portion 12, and a cable 14 connected to a rear end of the connection portion 12. A resilient latch 121 slantingly extends back and up from a front end of the connection portion 12. A recess 123 is defined in a bottom of the connection portion 12, near the cable 14.

The auxiliary device 20 includes a fastening member 30 and a resilient tab 40. The fastening member 30 includes a first fastening portion 31 and a second fastening portion 33 connected to a rear side of the first fastening portion 31. The first fastening portion 31 includes a top wall 312, two sidewalls 314 extending down from opposite sides of the top wall 312, and a connection wall 316 connected to rear sides of the top wall 312 and the sidewalls 314. A hook 318 extends from a bottom of each sidewall 314 toward the other sidewall 314. The second fastening portion 33 is connected to the connection wall 316. The second fastening portion 33 longitudinally defines a receiving slot 332 extending through the connection wall 316. The receiving slot 332 includes an inlet 331 extending through a bottom of the second fastening portion 33. The resilient tab 40 slantingly extends forward and upward from a rear end of a top of the second fastening portion 33. A motion portion 41 is formed on a front end of the resilient tab 40. The motion portion 41 is located above the top wall 312, and is substantially parallel to the top wall 312.

In assembly, the first fastening portion 31 is placed around a rear portion of the connection portion 12. The connection wall 316 abuts against the rear end of the connection portion 12. The hooks 318 engage in the recess 123. The cable 14 extends through the inlet 331 and is received in the receiving slot 332. The motion portion 41 is located above a rear end of the latch 121.

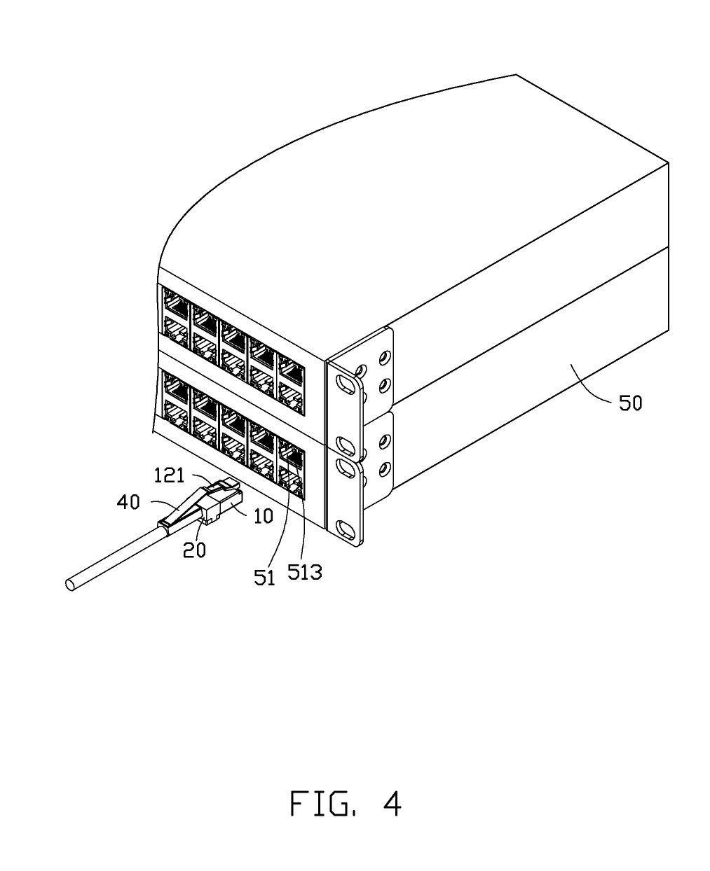

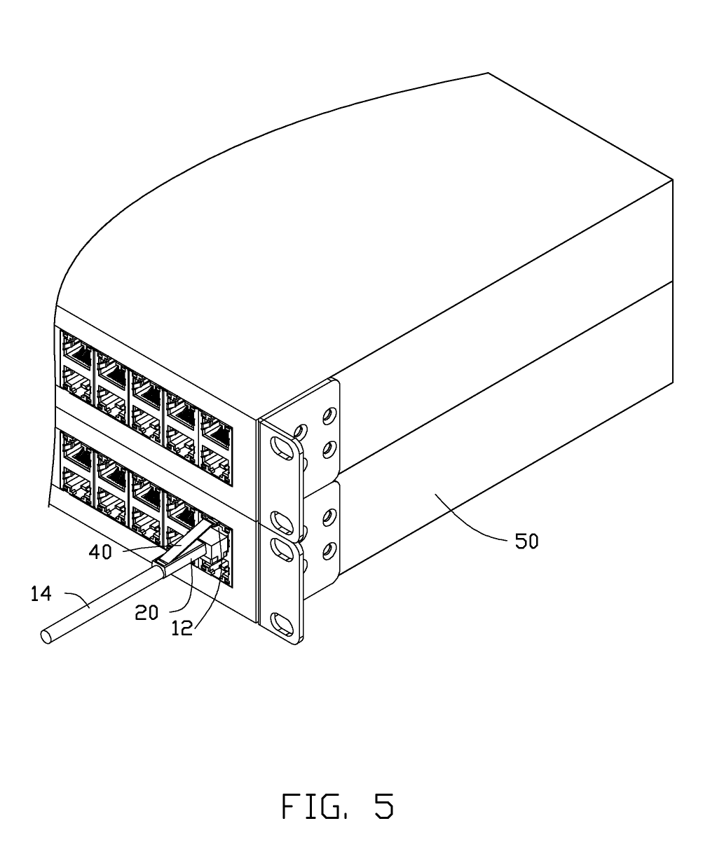

FIGS. 4 and 5 show in use, a front end of the connection portion 12 engages in an interface 51 of an electronic device 50. The latch 121 engages in a hooking slot 513 defined in the interface 51.

To pull the connector 10 out, the resilient tab 40 is pressed down. The motion portion 41 presses down the latch 121, to allow the latch 121 to disengage from the hooking slot 513. An operator can manipulate the resilient tab 40 spaced a certain distance from the interface 51 to press the latch 121, which is convenient.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A connector assembly, comprising:
a connector comprising a connection portion, and a cable connected to a rear end of the connection portion, a latch slantingly extending up and back from a front end of the connection portion; and
an auxiliary device comprising a fastening member fastened to the connector, and a resilient tab slantingly extending up and forward from the fastening member, a front end of the resilient tab located above the latch.

2. The connector assembly of claim 1, wherein the fastening member comprises a first fastening portion fastened to a rear portion of the connection portion, and a second fastening portion connected to the first fastening portion and receiving the cable, the resilient tab extends from the second fastening portion.

3. The connector assembly of claim 2, wherein a recess is defined in a bottom of the connection portion near the cable, the first fastening portion comprises a top wall supported on the connection portion, two sidewalls extending down from opposite sides of the top wall, and a connection wall connected to rear sides of the top wall and the sidewalls, the connection wall abuts against the rear end of the connection portion, a hook extends from a bottom of each sidewall and engages in the recess.

4. The connector assembly of claim 3, wherein the second fastening portion longitudinally defines a receiving slot extending through the connection wall, the receiving slot comprises an inlet extending through a bottom of the second fastening portion, the cable extends through the inlet and is received in the receiving slot.

5. The connector assembly of claim 3, wherein a motion portion substantially parallel to the top wall is formed on a front end of the resilient tab, the motion portion is located above the latch.
